(19) United States
(12) Patent Application Publication
(10) Pub. No.: US 2022/0351176 A1
(43) Pub. Date: Nov. 3, 2022

(54) PAYMENT INFORMATION PROCESSING METHOD, WEARABLE DEVICE, AND NON-VOLATILE COMPUTER-READABLE STORAGE MEDIUM

(71) Applicant: GUANGDONG OPPO MOBILE TELECOMMUNICATIONS CORP., LTD., Dongguan (CN)

(72) Inventor: Enfu LIU, Dongguan (CN)

(21) Appl. No.: 17/811,205

(22) Filed: Jul. 7, 2022

Related U.S. Application Data
(63) Continuation of application No. PCT/CN2021/070551, filed on Jan. 7, 2021.

(30) Foreign Application Priority Data
Jan. 7, 2020 (CN) 202010015233.4

(51) Int. Cl. G06Q 20/32; G06Q 20/40; G06Q 20/38

(52) U.S. Cl. CPC G06Q 20/3223; G06Q 20/3274; G06Q 20/325; G06Q 20/40145; G06Q 20/3829; G06Q 2220/00

(57) ABSTRACT

A payment information processing method, a wearable device, and a non-volatile computer-readable storage medium are provided. The payment information processing method includes the following. A payment identification code is obtained by a first system when a wearable device is in a network connection state. The payment identification code is transmitted to a second system and the payment identification code is stored through the second system. When the wearable device meets a condition and receives a payment request, the stored payment identification code is obtained from the second system. The payment identification code is displayed.

### CROSS-REFERENCE TO RELATED DISCLOSURE(S)

This application is a continuation of International Application No. PCT/CN2021/070551, filed Jan. 7, 2021, which claims priority to Chinese Patent Application No. 202010015233.4, filed Jan. 7, 2020, the entire disclosures of which are incorporated herein by reference.

### TECHNICAL FIELD

This disclosure relates to the field of electronic payment technology, and in particular, to a payment information processing method, a wearable device, and a non-volatile computer-readable storage medium.

### BACKGROUND

With the development of electronic payment technology, it is increasingly common to generate or scan payment identification codes such as QR codes and barcodes through smart devices. At present, some wearable device manufacturers integrate a mobile payment function in wearable devices. For example, when a payment request is received, a payment identification code can be generated for payment, or payment can be completed through a connected mobile terminal.

### SUMMARY

A payment information processing method is performed by a wearable device, the wearable device includes a first system and a second system, and the method includes the following.

A payment identification code is obtained through the first system when the wearable device is in a network connection state. The payment identification code is transmitted to the second system and the payment identification code is stored through the second system. When the wearable device meets a condition and receives a payment request, the stored payment identification code is obtained from the second system. The payment identification code is displayed.

A wearable device includes a memory, a first processor, and a second processor. The memory is configured to store a first computer program which, when executed by the first processor, is configured to cause the wearable device to operate a first system and store a second computer program which, when executed by the second processor, is configured to cause the wearable device to operate a second system, and the wearable device is configured to implement following operations.

A payment identification code is generated by a first system when the wearable device is in a network connection state. The payment identification code is transmitted to a second system and the payment identification code is stored through the second system. When the wearable device meets a condition and receives a payment request, the stored payment identification code is obtained from the second system. The payment identification code is displayed.

A non-volatile computer-readable storage medium stores a computer program executed by a processor of a wearable device to cause the processor to implement following operations.

A payment identification code is generated by a first system when the wearable device is in a network connection state. The payment identification code is transmitted to a second system and the payment identification code is stored through the second system. When the wearable device meets a condition and receives a payment request, the stored payment identification code is obtained from the second system. The payment identification code is displayed.

Details of one or more implementations of the disclosure are set forth in accompanying drawings and descriptions below. Other features, objects, and advantages of the present disclosure will become apparent from the descriptions, the accompanying drawings, and claims.

### BRIEF DESCRIPTION OF THE DRAWINGS

To describe technical solutions in implementations of the present disclosure or in the related art more clearly, the following briefly introduces accompanying drawings required for illustrating the implementations. Apparently, the accompanying drawings in the following description illustrate some implementations of the present disclosure. Those of ordinary skill in the art may also obtain other drawings based on these accompanying drawings without creative efforts.

FIG. 1 is a schematic diagram of an internal structure of a wearable device provided in an implementation.

FIG. 2 is a flow chart of a payment information processing method provided in an implementation.

FIG. 3 is a flow chart of a payment information processing method provided in another implementation.

FIG. 4 is a flow chart of a payment information processing method provided in another implementation.

FIG. 5 is a schematic diagram of a function control system of a wearable device provided in an implementation.

FIG. 6 is a flow chart of a payment information processing method provided in another implementation.

FIG. 7 is a schematic structural diagram of a payment information processing apparatus provided in an implementation.

FIG. 8 is a schematic structural diagram of a wearable device provided in an implementation.

### DETAILED DESCRIPTION

In order to make objectives, technical solutions, and advantages of the present disclosure more clear, the present disclosure will be further described in detail below with reference to accompanying drawings and implementations. It should be understood that specific implementations are described herein for the purpose of explaining the disclosure rather than limiting the disclosure

It can be understood that, the terms “first”, “second”, etc., may be used herein to describe various elements and parameters, but these elements and parameters are not limited by these terms. For example, these terms may be used to distinguish a first element from another element. For example, a first system could be referred to as a second system, and, similarly, a second system could be referred to as a first system, without departing from the protection scope of the disclosure. Both the first system and the second system are systems, but they are not the same system.

In related art, the mobile payment function of wearable devices often relies on connections with wireless networks or mobile terminal. In application scenarios such as being unable to connect with wireless networks or mobile terminals, or a network signal is weak, the wearable device is unable to provide the convenient payment function. A payment information processing method, a wearable device, and a non-volatile computer-readable storage medium are provided in implementations of the present disclosure, which can provide a convenient payment function in different application scenarios.

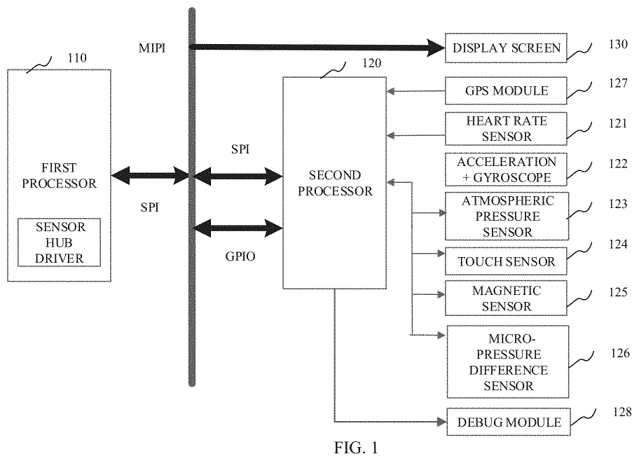

FIG. 1 is a schematic diagram of an internal structure of a wearable device provided in an implementation. As illustrated in FIG. 1, in one implementation, the provided wearable device includes a first processor 110 corresponding to the first system and a second processor 120 corresponding to the second system. Both the first processor 110 and the second processor 120 are microprocessors, where the first processor 110 is a core processor. The first processor 110 and the second processor 120 may be configured as corresponding microprocessors according to actual applications, and the first processor 110 and the second processor 120 are not limited herein. For example, the first processor 110 may be a central process unit (CPU) processor, and the corresponding first system may be an Android system; and the second processor 120 may be a microcontroller unit (MCU) processor, and the corresponding second system may be a real time operating system (RTOS) system.

For example, the wearable device may include one or more of: a heart rate sensor 121, an acceleration+gyroscope 122, an atmospheric pressure sensor 123, a touch sensor 124, a magnetic sensor 125, a micro-pressure difference sensor 126, or other sensors. The second processor 120 can be connected with sensors of the wearable device for obtaining data collected by the sensors. The second processor 120 can also be connected with a global positioning system (GPS) module 127 for obtaining positioning data received by a GPS antenna; and connected with a debug module 128 for outputting debug data of the wearable device.

The first processor 110 and the second processor 120 are connected through a serial peripheral interface (SPI), so that the first system and the second system can transmit communication data through the SPI bus. The display screen 130 is connected with the first processor 110 and the second processor 120 through a mobile industry processor interface (MIPI), and can display data output by the first processor 110 or the second processor 120. The first processor 110 also includes a sensor hub driver, which can be used to drive data collection and data processing of each sensor.

In one implementation, the wearable device can be operable in at least two working modes: a watch mode and a wristband mode. When the wearable device is in the watch mode, both the first system and the second system run, and the wearable device is under control of the first system. When the wearable device is in the bracelet mode, the first system is shut down, the second system runs, and the wearable device is under control of the second system.

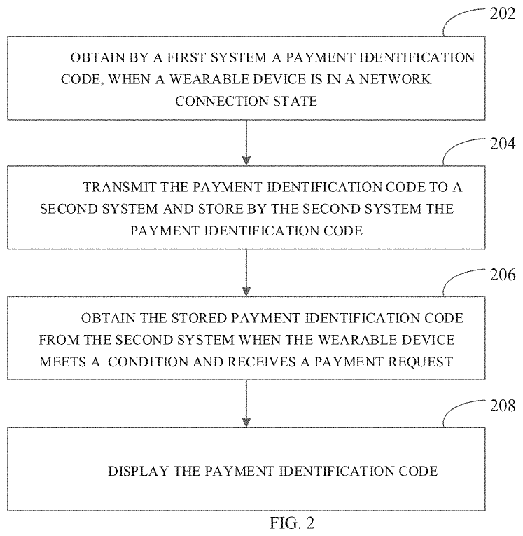

FIG. 2 is a flow chart of a payment information processing method provided in an implementation. As illustrated in FIG. 2, in one implementation, for illustrative purpose, the payment information processing method is applicable to a wearable device, and the payment information processing method includes the following.

At block 202, when the wearable device is in a network connection state, a payment identification code is obtained through the first system.

In some implementations, the network connection state means that the wearable device is connected with a wireless access point, and can wirelessly communicate with a server or a mobile terminal through a wireless network. The wireless access point can be a networking device that allows Wi-Fi devices to connect to a wired network. They form wireless local-area networks (WLANs). An access point acts as a central transmitter and receiver of wireless radio signals. The access point can be incorporated into a wired router or a stand-alone router. The WLAN may differ from Bluetooth in a distance range, a bandwidth, a speed, or the like. It can be understood that the first system has a network connection function and the wearable device can be connected with a wireless access point directly when the wearable device is under control of the first system. As such, the first system can generate the payment identification code when the first system is connected with a network. The payment identification code generated here is not limited to one code, and more than one payment identification code can be generated, and the specific number is related to usage time and storage space. For example, the specific number can be set to 10, 15, 20, etc. In some implementations, the second system does not have the network connection function (e.g. the second system is unable to be connected with a wireless access point directly) and is more secure. In one case, both the first system and the second system run, and the first system can be connected with a network; in another case, the first system does not run, and only the second system runs, and therefore the second system is unable to be connected with the network (e.g. the second system is unable to be connected with a wireless access point directly); and of course in other cases, the second system may not run while the first system runs, which can be set according to actual application requirements.

It should be noted that the payment identification code can refer to an identification code used to provide a payment entry. The payment identification code may be a barcode, a QR code, or the like.

In the implementation of the present disclosure, the wearable device can connect with the network through the first system to generate the payment identification code through the first system when the first system is running. For example, the wearable device is connected with a payment platform through the first system for network communication. In the network connection state, through the first system, the wearable device can obtain account information of the wearable device from the payment platform (such as Alipay™, WeChat™, etc.), and generate the payment identification code according to the account information. As another implementation, the wearable device can obtain the payment identification code generated by the payment platform through the first system.

At block 204, the payment identification code is transmitted to the second system and the payment identification code is stored through the second system.

Security of the second system is higher than that of the first system. For example, the first system is equivalent to a main operating system of the wearable device and can provide relatively complete functions of the wearable device, for example, high-speed data transmission with a connected mobile terminal, detection and analysis of biological data, accurate positioning, communication, etc. can be realized through the first system. The second system is equivalent to an auxiliary operating system of the wearable device, which can provide basic functions of the wearable device, such as time display, information reminder, sensor data collection, and low-speed data transmission with a connected mobile terminal, etc.

The wearable device can transmit the generated payment identification to the second system, and the second system stores the payment identification code, which can ensure security of the payment identification code.

At block 206, when the wearable device meets a condition and receives a payment request, the stored payment identification code is obtained from the second system.

The wearable device may obtain the stored payment identification code from the second system when the condition is met and the payment request is received. For example, the wearable device may obtain at least one of network information and power information of the wearable device upon receiving the payment request, and when the wearable device is determined to meet the condition according to at least one of the network information and the power information, the stored payment identification code is obtained from the second system. The network information includes a network status and a network signal strength, and the power information includes remaining power. According to different conditions, the wearable device may obtain the at least one of network information and power information of the wearable device to determine whether the condition is met. For example, when the condition is that the wearable device is in an offline state, the wearable device may obtain the network information to determine whether the condition is met.

The condition includes at least one of: the wearable device is in an offline state, a network signal strength of the wearable device is less than a value, or remaining power of the wearable device is less than a first power threshold. For example, the offline state is defined relative to the network connection state mentioned above. When the wearable device is in the offline state, the wearable device is unable to be connected with a network by being connected with a wireless access point. The offline state may include following cases. For example, the wearable device is under control of the first system and the wearable device is unable to be connected with a network by being connected with a wireless access point, due to no available wireless access points nearby. For another example, the wearable device is under control of the second system and the second system is unable to be connected with a wireless access point directly. For yet another example, the wearable device is unable to be connected with another mobile terminal with a network connection function. In other words, the condition that the wearable device is in an offline state may include at least one of that the wearable device is unable to be connected with a network under the control of the first system, the wearable device is under control of the second system, or the wearable device is not connected with a mobile terminal, and the like. For example, the condition may be that the wearable device is in the offline state, then the wearable device may obtain the stored payment identification code from the second system when the wearable device is determined to be in the offline state and receives the payment request. The condition may also be that network signal strength of the wearable device is less than the value, and the remaining power of the wearable device is less than the first power threshold, then when the wearable device receives the payment request, whether the wearable device meets the following condition is determined: whether the network signal strength is less than the value and whether the remaining power is less than the first power threshold value. If the network signal strength is less than the value and the remaining power is less than the first power threshold value, the stored payment identification code is obtained from the second system.

For example, when the wearable device is under control of the first system and the wearable device is unable to be connected with a network by being connected with a wireless access point, the first system can obtain the stored payment identification code from the second system when the first system receives a payment request. For another example, when the wearable device is under control of the second system, the second system can obtain the stored payment identification code when the second system receives a payment request.

It can be understood that the offline state refers to a state in which the wearable device has not established a connection with a wireless access point and is unable to realize a wireless communication function. When the network signal strength is less than the value, the payment identification code is generated too slowly or difficult to be generated. When the remaining power is less than the first power threshold, it indicates that the power is too low, if the first system continues to be used and the payment code is obtained from Internet, more power will be consumed. Therefore, in the above-mentioned situations, it is more appropriate to obtain the payment identification code pre-stored in the second system for payment. Of course, the offline state also includes a situation where the wearable device is currently under control of the second system, that is, only the second system is running, and then the payment code in the second system can be directly used without switching to the first system at this time. In addition, the payment request may be generated by pressing a button of the wearable device by the user, or may be generated by the user touching a control on the touch screen of the wearable device, etc. The wearable device may obtain and generate the payment request.

At block 208, the payment identification code is displayed.

The wearable device can display the obtained payment identification code on the display screen. The displayed payment identification code can be scanned by other devices, so that the other devices can obtain the payment entry of the account information corresponding to the wearable device, and complete a corresponding collection operation.

In implementations of the present disclosure, when the wearable device is in the network connection state, the payment identification code is generated through the first system and transmitted to the second system. The second system stores the payment identification code. When the wearable device meets the condition and receives the payment request, the stored payment identification code is obtained from the second system and displayed. In other words, the payment identification code can be generated through the first system in advance and stored in the second system. When the payment request is received in scenarios such as offline, weak network signal, low power, etc., the stored payment identification code can be obtained from the second system for payment. As such, a convenient payment function can be achieved in different application scenarios, and security of payment information can be ensured.

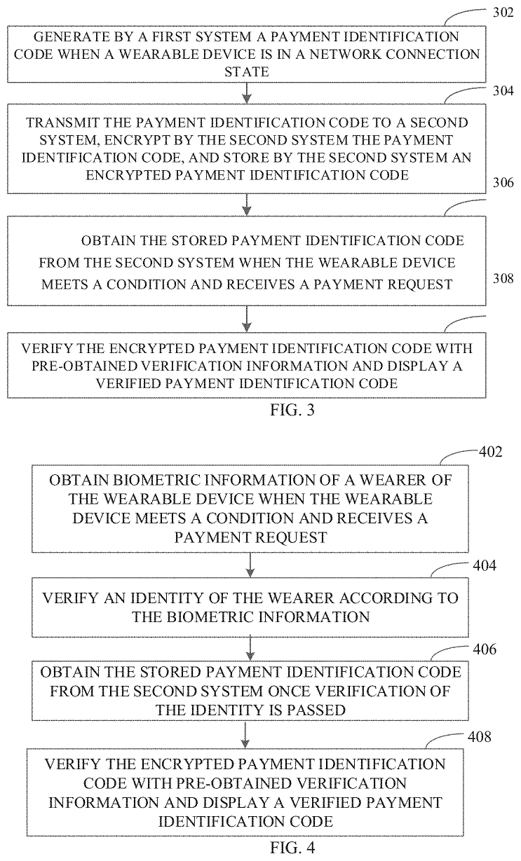

FIG. 3 is a flow chart of a payment information processing method provided in another implementation. As illustrated in FIG. 3, in one implementation, the payment information processing method includes the following.

At block 302, when the wearable device is in a network connection state, a payment identification code is generated through the first system.

At block 304: the payment identification code is transmitted to the second system, the payment identification code is encrypted through the second system, and an encrypted payment identification code is stored through the second system.

The wearable device transmits the payment identification code generated through the first system to the second system, the payment identification code is encrypted through the second system, and the encrypted payment identification code is stored through the second system.

In one implementation, the second system may use an asymmetric encryption algorithm to encrypt the payment identification code. A pair of keys are required for the asymmetric encryption algorithm, that is, a public key and a private key. The private key can deduce the public key, but the public key is unable to deduce the private key. Data encrypted with the public key can only be decrypted with the corresponding private key; and data encrypted with the private key can only be decrypted with the corresponding public key. For example, the wearable device can generate a pair of private key and public key through the second system, so as to use the private key to encrypt the payment identification code and transmit the public key corresponding to the private key to the first system.

At block 306, when the wearable device meets a condition and receives a payment request, the stored payment identification code is obtained from the second system.

At block 308, the encrypted payment identification code is verified with pre-obtained verification information, and a verified payment identification code is displayed.

The pre-obtained verification information is corresponding to encrypted information, and can be used to verify the payment identification code. The wearable device can verify the encrypted payment identification code with the pre-obtained verification information.

In one implementation, the pre-obtained verification information is the public key corresponding to the private key with which the payment identification code is encrypted. The payment identification code can be decrypted according to the public key. If decryption is successful, the payment identification code is verified, and the verified payment identification code is displayed; if the decryption is unsuccessful, the payment identification code is not verified. As an implementation, when the payment identification code is not verified, the wearable device may re-obtain other stored payment identification codes from the second system.

In one implementation, in the payment information processing method provided, the payment identification code can also be encrypted through the first system. For example, the first system can generate a pair of a private key and a public key, and transmit the public key to the second system; when the first system generates the payment identification code, the first system encrypts the payment identification code according to the generated private key, and transmits an encrypted payment identification code to the second system to be stored through the second system; when the first system receives the payment request, the first system obtains the encrypted payment identification code from the second system, and determines the public key according to the held private key, and verifies the encrypted payment identification code; and when the second system receives the payment request, the second system can obtain the stored encrypted payment identification code, and verify the payment identification code according to the public key transmitted through the first system.

When receiving the payment identification code transmitted through the first system, the second system encrypts the payment identification code and stores the encrypted payment identification code. When a payment request is received, the stored encrypted payment identification code can be obtained, and the encrypted payment identification code is verified according to the pre-obtained verification information, and the verified payment identification code is displayed, which can improve the security of the payment information.

FIG. 4 is a flow chart of a payment information processing method provided in another implementation. As illustrated in FIG. 4, in one implementation, the provided payment information processing method includes the following.

At block 402, when the wearable device meets a condition and receives a payment request, biometric information of a wearer of a wearable device is obtained.

The biometric information may be, but is not limited to, one or more of: fingerprint information, heart rate information, blood pressure information, face information, iris information, or the like of the wearer. The biometric information can be used to verify an identity of the wearer. When the wearable device is worn, the wearable device can obtain the biometric information of the wearer through a built-in sensor.

When the wearable device meets the condition and receives the payment request, the wearable device can obtain the biometric information of the wearer.

At block 404, the identity of the wearer is verified according to the biometric information.

The wearable device verifies the identity of the wearer according to the biometric information. For example, the wearable device has pre-stored biometric information of the owner of the wearable device. By comparing the biometric information of the owner with the biometric information of the wearer, it can be verified whether the wearer is the owner of the wearable device.

The biometric information of the owner may be entered into the wearable device in advance by the owner, or detected by the wearable device when the owner wears the wearable device. The owner of the wearable device can be one or more.

At block 406, the stored payment identification code is obtained from the second system once verification of the identity is passed.

When the verification of the identity is passed, it indicates that the current wearer is the owner of the wearable device, and the wearable device can obtain the stored payment identification code from the second system according to the obtained payment request. When the verification of the identity fails to be passed, it indicates the wearer is not the owner of the wearable device, and the wearable device may prompt no payment permission.

At block 408, the payment identification code is displayed.

The biometric information of the wearer is obtained when the payment request is received, the identity of the wearer is verified according to the biometric information, and the stored payment identification code is obtained and displayed when the verification is passed, as such, security of payment can be further improved.

In some implementations, in the provided payment information processing method, the payment identification code is obtained through the first system when the wearable device is in the network connection state as follows. When the wearable device is in the network connection state, a current moment is obtained; and at least one payment identification code is obtained through the first system when the current moment belongs to a time period.

The time period may be a period in which the wearable device is operated less frequently. For example, the time period may be 0:00-1:00; 5:00-6:00; 23:00-23:30, etc. When a current system of the wearable device is the first system and the current moment is within the time period, the wearable device can obtain the at least one payment identification code through the first system. The number of payment identification codes obtained by the wearable device can be set according to actual application requirements, which is not set here, for example, it may be 5, 10, 20, etc.

The network connection state means that the wearable device is connected with a wireless access point, and can wirelessly communicate with a server or a mobile terminal through a wireless network. The wireless access point can be a networking device that allows Wi-Fi devices to connect to a wired network. They form wireless local-area networks (WLANs). An access point acts as a central transmitter and receiver of wireless radio signals. The access point can be incorporated into a wired router or a stand-alone router. The wearable device can determine whether the wearable device is in an offline state or a network connection state according to a current network state.

In some implementations, when the wearable device is in the network connection state, at least one payment identification code is obtained through the first system according to a time interval. For example, the wearable device can obtain the network state of the wearable device, and when the network state is the network connection state, the at least one payment identification code is obtained according to the time interval to update payment identification codes in the second system. The time interval may be set according to valid time of a payment identification code. For example, the time interval is less than or equal to the valid time of the payment identification code. For example, when the valid time of the payment identification code is 60 minutes, the time interval may be 30 minutes, 40 minutes, 50 minutes, 60 minutes, or the like.

In some implementations, when the number of unused payment identification codes stored through the second system is less than a number and the wearable device is in the network connection state, at least one payment identification code is obtained through the first system. For example, the wearable device can also obtain through the first system the number of unused payment identification codes stored through the second system, and when the number is less than the number and the wearable device is in the network connection state, proceed to generating the payment identification code through the first system. The number may be 5, 8, 10, or the like. Different settings of the number will lead to different effects. Assuming that the second system stores 20 payment identification codes, when the number is set to 10, for example, each time the network is connected, a number detection is performed. When the number of unused payment identification codes is less than 10, an update is performed. The update may be an update of all payment identification codes, that is, to clear the unused payment identification codes in the second system, and obtain 20 payment identification codes through the first system. The update may also be an update of used payment identification code, that is, to obtain the same number of payment identification codes as the used payment identification codes through the first system. This method can update stored payment identification codes in real time.

Further, when the number is set to 1, that is, when all payment identification codes stored in the second system are used up and the wearable device is in the network connection state, at least one payment identification code is obtained through the first system. For example, if the number of all payment identification codes stored in the second system is 10, and when all 10 payment identification codes are used up, update at once, that is, the payment identification codes are obtained through the first system. Use of a payment identification code means that the wearable device obtains the payment identification code from the second system and displays it, that is, when the payment identification code is displayed, it is considered that the payment identification code has been used. The wearable device can set a displayed payment identification code as an invalid payment identification code in order to avoid repeated use, and the invalid payment identification code can no longer be displayed.

As an implementation, the wearable device can obtain the payment identification code from the second system according to generation time of the payment identification code. For example, the wearable device can preferentially obtain the payment identification code whose generation time is the longest from the current moment, that is, use an old one first.

The payment identification code is obtained through the first system when the current moment is within the time period, and transmitted to the second system for storage, which can avoid affecting other operations of the wearable device and ensure operation stability of the wearable device. By setting the time interval, validity of the payment identification code can be guaranteed, and by setting factors such as a usage number, the payment identification code can be updated in time for use.

In one implementation, the provided payment information processing method further includes: when the wearable device is in the network connection state and receives a payment request, a payment identification code is obtained through the first system, and the payment identification code is displayed.

When the wearable device is in the network connection state, the wearable device has a function of generating the payment identification code through the first system. Therefore, when the wearable device is in the network connection state and receives the payment request, the payment identification code can be obtained through the first system and displayed. In other words, the payment identification code can be obtained through the first system and displayed when the wearable device receives the payment request in the network connection state.

In one implementation, the payment information processing method further includes: when the wearable device is under control of the first system, remaining power of the wearable device is obtained; when the remaining power is less than a second power threshold, shut down the first system of the wearable device and switch to be under control of the second system; when the wearable device is under control of the second system and a payment request is received, the stored payment identification code is obtained through the second system, and the payment identification code is displayed.

The remaining power of the wearable device refers to a proportion of available power in the battery of the wearable device to a nominal capacity. The second power threshold may be determined according to actual usage requirements. For example, the second power threshold may be 10%, 15%, 20%, 30%, etc. but not limited thereto. The first system can provide relatively complete functions of the wearable device, and the second system provides basic functions of the wearable device, so power consumption of the wearable device operating the first system is greater than power consumption of the wearable device operating the second system. The wearable device can detect the remaining power in real time, and when the remaining power is less than a power threshold, shut down the first system of the wearable device and switch to be under control of the second system.

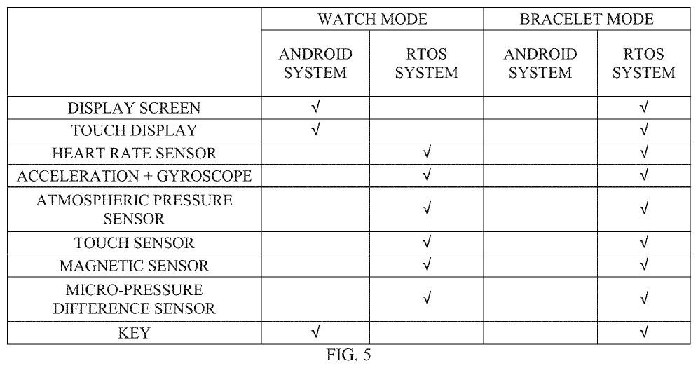

FIG. 5 is a schematic diagram of a function control system of a wearable device provided in an implementation. As illustrated in FIG. 5, for illustrative purpose, the first system is an Android system, and the second system is an RTOS system, the wearable device is operable in at least two operating modes, for example, a watch mode and a bracelet mode, the wearable device operates both the Android system and the RTOS system in the watch mode, the wearable device shuts down the Android system and only operates the RTOS system in the bracelet mode. A heart rate sensor, an electrocardiograph (ECG) sensor, a motion sensor, and other sensors are under control of the RTOS system in the watch mode and in the bracelet mode. A display screen, a touch screen, and a key can be controlled by different systems in different modes, that is, in the watch mode, the display, the touch screen, and the key can be controlled by the Android system, and in bracelet mode, the display, the touch screen, and the key can be controlled by the RTOS system.

When the wearable device is under control of the first system, the payment request input by the user can be obtained through the touch screen or the key; when the first system is shut down and the wearable device is under control of the second system, the payment request input by the user can also be obtained through the touch screen or the key.

When the wearable device is under control of the second system, the payment request can be obtained through the second system, the stored payment identification code can be obtained according to the payment request, and the payment identification code can be displayed. The stored payment identification code is a payment identification code obtained through the first system and transmitted to the second system when the wearable device is in the network connection state.

When the wearable device is under control of the first system, the remaining power of the wearable device is obtained. When the remaining power is less than the second power threshold, shut down the first system of the wearable device and switch to be under control of the second system; when the wearable device is under control of the second system and receives the payment request, the stored payment identification code is obtained through the second system, and the payment identification code is displayed, which can realize a payment function in a low power consumption mode and ensure security of payment.

In one implementation, the processor corresponding to the first system and the processor corresponding to the second system are connected through a serial peripheral interface (SPI) bus. In the payment information processing method, the payment identification code is transmitted to the second system and the payment identification code is stored through the second system as follows. The payment identification code is transmitted to the processor corresponding to the second system through the SPI bus; and the payment identification code is stored by a memory corresponding to the second system.

The processor corresponding to the first system and the processor corresponding to the second system are connected through the SPI bus. For example, the processor corresponding to first system is a CPU processor, the processor corresponding to the second system is a MCU processor, and the CPU processor and the MCU processor can be connected through the SPI bus and perform data transmission through the SPI bus.

In this implementation, the wearable device can transmit the payment identification code obtained through the first system to the second system through the SPI bus to be stored in the memory of the second system. As an implementation, the memory may be a flash memory or other non-volatile memory, which is not limited herein.

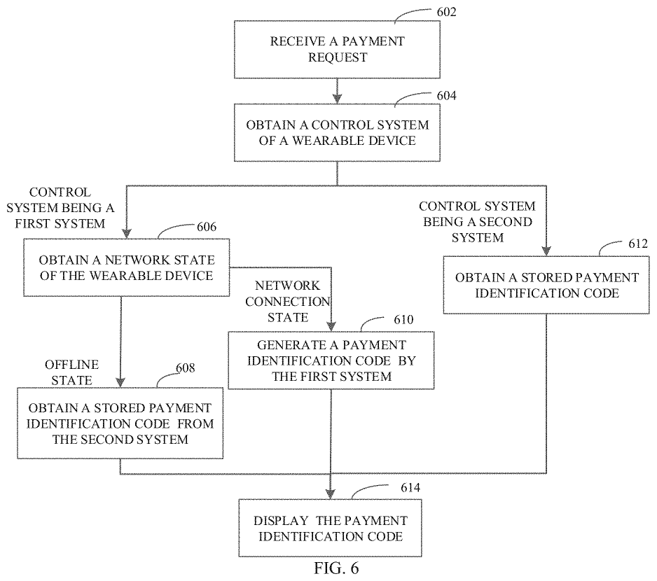

FIG. 6 is a flow chart of a payment information processing method provided in another implementation. As illustrated in FIG. 6, in the payment information processing method, for illustrative purpose, the condition is that the wearable device is in an offline state, the method includes the following.

At block 602, a payment request is received.

At block 604, a control system of the wearable device is determined; if the control system is the first system, proceed to operations at block 606; if the control system is the second system, proceed to operations at block 612.

At block 606, a network state of the wearable device is obtained; when the network state is the offline state, proceed to operations at block 608; when the network state is a network connection state, proceed to operations at block 610.

At block 608, a stored payment identification code is obtained from the second system, and proceed to operations at block 614.

At block 610, a payment identification code is generated through the first system, and proceed to operations at block 614.

At block 612, the stored payment identification code is obtained.

At block 614, the payment identification code is displayed.

It should be understood that although operations in the flowcharts of FIGS. 2-4 and 6 are sequentially displayed according to arrows, these operations are not necessarily executed in the order indicated by the arrows. Unless explicitly stated herein, the execution of these operations is not strictly limited to the order, and these operations may be performed in other orders. Moreover, at least a part of operations in FIGS. 2-4 and 6 may include multiple sub-operations or multiple stages. These sub-operations or stages are not necessarily completed at the same time, but may be executed at different times. These sub-operations or stages are not necessarily executed sequentially, but may be executed alternately with at least a portion of other operations, or sub-operations or stages of other operations.

These sub-operations are not necessarily at the same time. Alternatively, the order of execution of the stages is not necessarily sequential, but may be performed alternately or alternately with other operations or sub-operations of other operations or at least a portion of a stage.

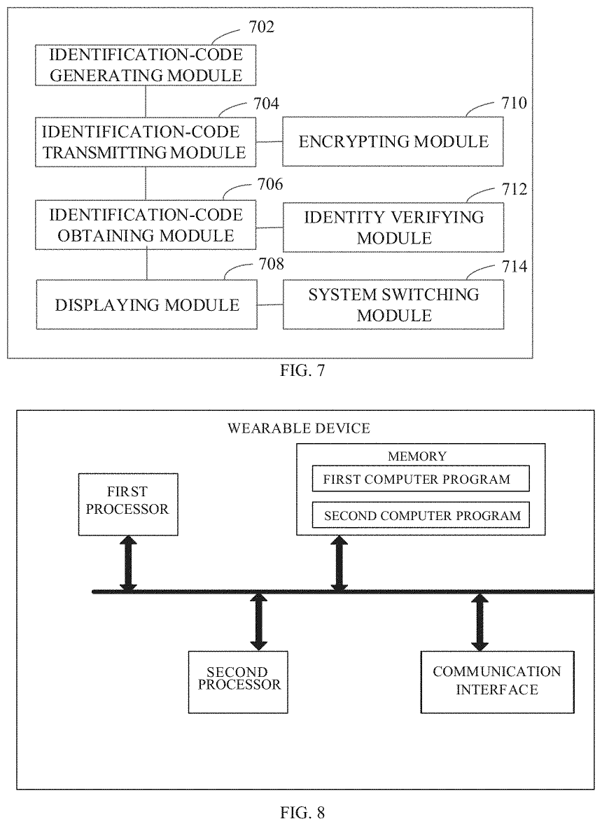

FIG. 7 is a schematic structural diagram of a payment information processing apparatus provided in an implementation. As illustrated in FIG. 7, the payment information processing apparatus includes an identification-code generating module 702, an identification-code transmitting module 704, an identification-code obtaining module 706, and a displaying module 708.

The identification-code generating module 702 is configured to generate by a first system a payment identification code when a wearable device is in a network connection state.

The identification-code transmitting module 704 is configured to transmit the payment identification code to a second system and store through the second system the payment identification code.

The identification-code obtaining module 706 is configured to obtain the stored payment identification code from the second system when the wearable device meets a condition and receives a payment request.

The displaying module 708 is configured to display the payment identification code.

With the payment information processing apparatus provided in implementations, when the wearable device is in the network connection state, the payment identification code is generated through the first system and transmitted to the second system. The second system stores the payment identification code. When the wearable device meets the condition and receives the payment request, the stored payment identification code is obtained from the second system and displayed. In other words, the payment identification code can be generated through the first system in advance and stored in the second system. When the payment request is received under the condition, the stored payment identification code can be obtained from the second system for payment. As such, a convenient payment function can be achieved in different application scenarios such as being unable to connect with wireless networks or mobile terminals, or a network signal is weak, and security of payment information can be ensured.

In an implementation, the payment information processing apparatus further includes an encrypting module 710. The encrypting module 710 is configured to encrypt through the second system the payment identification code and store through the second system an encrypted payment identification code; the identification-code obtaining module 706 is further configured to verify the encrypted payment identification code with a pre-obtained verification information; and the displaying module 708 is configured to display a verified payment identification code.

In an implementation, the payment information processing apparatus further includes an identity verifying module 712. The identity verifying module 712 is configured to obtain biometric information of a wearer of the wearable device; and verify an identity of the wearer according to the biometric information.

In an implementation, the identification-code generating module 702 is further configured to: obtain a current moment when the wearable device is in the network connection state, and obtain through the first system at least one payment identification code when the current moment belongs to a time period.

In an implementation, the identification-code generating module 702 is further configured to obtain through the first system at least one payment identification code according to a time interval when the wearable device is in the network connection state.

In an implementation, the identification-code generating module 702 is further configured to generate through the first system at least one payment identification code when a number of unused payment identification codes stored through the second system is less than a number and the wearable device is in the network connection state.

In an implementation, the identification-code obtaining module 706 is further configured to: obtain at least one of network information and power information of the wearable device upon receiving the payment request; and obtain the stored payment identification code from the second system upon determining, according to the at least one of network information and power information, that the wearable device meets the condition.

In an implementation, the identification-code obtaining module 706 is configured to obtain the stored payment identification code from the second system when the wearable device receives a payment request and at least one of: the wearable device is in an offline state, a network signal strength of the wearable device is less than a value, or remaining power of the wearable device is less than a first power threshold.

In an implementation, the payment information processing apparatus further includes a system switching module 714. The system switching module 714 is configured to obtain remaining power of the wearable device when the wearable device is under control of the first system; shut down the first system when the remaining power is less than a second power threshold and switch to be under control of the second system. The displaying module 708 is further configured to obtain through the second system the stored payment identification code when the wearable device is under control of the second system and receives a payment request, and display the payment identification code.

In an implementation, the displaying module 708 is configured to: generate through the first system the payment identification code, when the wearable device is in the network connection state and receives a payment request, and display the payment identification code.

In an implementation, the identification-code transmitting module 702 is further configured to transmit the payment identification code to the processor corresponding to the second system through a serial peripheral interface bus; and store by a memory corresponding to the second system the payment identification code.

The division of each module in the above payment information processing apparatus is only for illustration. In other implementations, the payment information processing apparatus may be divided into different modules as required to complete all or part of functions of the above payment information processing apparatus.

For the specific limitation of the payment information processing apparatus, reference can be made to the limitation of the payment information processing method above, which will not be repeated herein. Each module in the above payment information processing device can be implemented in whole or in part by software, hardware or a combination thereof. The above modules may be embedded in or independent from the processor of the wearable device in the form of hardware, or may be stored in the memory of the wearable device in the form of software, so as to be called by the processor to execute operations corresponding to the above modules.

As is consistent with the above-mentioned implementations illustrated in FIGS. 2-4 and 6, reference is made to FIG. 8, which is a structural schematic diagram of a wearable device provided in an implementation of the disclosure. As illustrated, the electronic device includes a memory, a first processor, and a second processor, where the memory is configured to store a first computer program which, when executed by the first processor, is configured to cause the wearable device to operate a first system and store a second computer program which, when executed by the second processor, is configured to cause the wearable device to operate a second system, and the wearable device is configured to implement the above the payment information processing method.

Implementations of the present disclosure also provide a computer-readable storage medium, that is a non-volatile computer-readable storage medium comprising one or more computer-executed instructions. The instructions, when executed by one or more processors, cause the processors to execute operations of the payment information processing method.

A computer program product, when running on a computer, cause the computer to execute the payment information processing method.

A memory, storage, database, or other medium as used herein may include non-volatile and/or volatile memory. The non-volatile memory may include a read only memory (ROM), a programmable ROM (PROM), an electrically programmable ROM (EPROM), an electrically erasable programmable ROM (EEPROM), or flash memory. The volatile memory may include a random access memory (RAM), which is used as an external cache memory. For purpose of illustration and not limitation, RAM is available in various forms such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Rambus, a direct RAM (RDRAM), a direct Rambus DRAM (DRDRAM), and a Rambus dynamic RAM (RDRAM).

The above implementations, which are described specifically and in detail, are mere some implementations of the present disclosure, but should not be construed as a limitation on the scope of the present disclosure. It should be noted that those skilled in the art may make modifications without departing from the concept of the present disclosure, all of which fall within the protection scope of the present disclosure. Therefore, the protection scope of the present disclosure shall be subject to the attached claims.

What is claimed is:

1. A payment information processing method performed by a wearable device comprising a first system and a second system, and the method comprising:
obtaining through the first system a payment identification code when the wearable device is in a network connection state;
transmitting through the first system the payment identification code to the second system and storing through the second system the payment identification code;
obtaining the stored payment identification code from the second system when the wearable device meets a condition and receives a payment request; and
displaying the payment identification code.

2. The method of claim 1, wherein storing through the second system the payment identification code comprises:
encrypting through the second system the payment identification code and storing through the second system an encrypted payment identification code, wherein
displaying the payment identification code comprises:
verifying the encrypted payment identification code with pre-obtained verification information and displaying a verified payment identification code.

3. The method of claim 1, wherein before obtaining the stored payment identification code from the second system, the method further comprises:
obtaining biometric information of a wearer of the wearable device;
verifying an identity of the wearer according to the biometric information; and
determining that verification of the identity is passed.

4. The method of claim 1, wherein obtaining through the first system the payment identification code comprises:
obtaining a current moment, and obtaining through the first system at least one payment identification code when the current moment belongs to a time period; or
obtaining through the first system at least one payment identification code according to a time interval; or,
obtaining through the first system at least one payment identification code when a number of unused payment identification codes stored through the second system is less than a number.

5. The method of claim 1, wherein obtaining the stored payment identification code from the second system when the wearable device meets the condition and receives the payment request comprises:
obtaining at least one of network information and power information of the wearable device upon receiving the payment request; and
obtaining the stored payment identification code from the second system upon determining, according to the at least one of network information and power information, that the wearable device meets the condition.

6. The method of claim 5, wherein the condition comprises at least one of: the wearable device is in an offline state, a network signal strength of the wearable device is less than a value, or remaining power of the wearable device is less than a power threshold.

7. The method of claim 1, further comprising:
obtaining remaining power of the wearable device when the wearable device is under control of the first system;
shutting down the first system when the remaining power is less than a power threshold and switching to be under control of the second system;
obtaining through the second system the stored payment identification code when the wearable device is under control of the second system and receives a payment request, and displaying the payment identification code.

8. The method of claim 1, further comprising:
obtaining through the first system the payment identification code, when the wearable device is in the network connection state and receives the payment request, and displaying the payment identification code.

9. The method of claim 1, wherein a processor corresponding to the first system and a processor corresponding to the second system are connected through a serial peripheral interface bus, and wherein,
transmitting the payment identification code to the second system and storing through the second system the payment identification code comprises:
transmitting the payment identification code to the processor corresponding to the second system through the serial peripheral interface bus; and
storing through a memory corresponding to the second system the payment identification code.

10. The method of claim 1, wherein the wearable device comprises a first processor corresponding to the first system and a second processor corresponding to the second system.

11. The method of claim 1, wherein the condition comprises that the wearable device is under control of the second system, or the wearable device is not connected with a mobile terminal.

12. The method of claim 11, wherein only the second system is running among the first system and the second system, when the wearable device is under control of the second system.

13. The method of claim 1, further comprising:
generating through the first system a pair of a private key and a public key and transmitting through the first system the public key to the second system;
encrypting through the first system the payment identification code according to the generated private key when the payment identification code is obtained through the first system, transmitting through the first system an encrypted payment identification code to the second system, and storing through the second system the encrypted payment identification code;
obtaining through the first system the encrypted payment identification code from the second system once receiving the payment request through the first system, determining through the first system the public key according to the private key held, and verifying through the first system the encrypted payment identification code; and
obtaining through the second system the stored encrypted payment identification code once receiving the payment request through the second system, and verifying through the second system the payment identification code according to the public key transmitted through the first system.

14. The method of claim 1, wherein power consumption of the wearable device operating the first system is greater than power consumption of the wearable device operating the second system.

15. The method of claim 1, wherein the wearable device is operable in at least two operating modes, and the at least two operating modes comprise a watch mode and a bracelet mode; and in the watch mode, the wearable device simultaneously operates the first system and the second system, and in the bracelet mode, the wearable device shuts down the first system and only operates the second system.

16. The method of claim 1, wherein the first system is an Android system, and the second system is a RTOS system.

17. A wearable device, comprising:
a memory, a first processor, and a second processor;
wherein the memory is configured to store a first computer program which, when executed by the first processor, is configured to cause the wearable device to operate a first system and store a second computer program which, when executed by the second processor, is configured to cause the wearable device to operate a second system, and the wearable device is configured to:
generate through the first system a payment identification code when the wearable device is in a network connection state;
transmit through the first system the payment identification code to the second system and storing through the second system the payment identification code;
obtain the stored payment identification code from the second system when the wearable device meets a condition and receives a payment request; and
display the payment identification code.

18. The wearable device of claim 17, wherein the condition comprises that the wearable device is under control of the second system, or the wearable device is not connected with a mobile terminal.

19. A non-transitory computer-readable storage medium for storing a computer program, wherein the computer program, when executed by wearable device, is configured to cause the wearable device to execute:
generating by a first system a payment identification code when the wearable device is in a network connection state;
transmitting through the first system the payment identification code to a second system and storing through the second system the payment identification code;
obtaining the stored payment identification code from the second system when the wearable device meets a condition and receives a payment request; and
displaying the payment identification code.

20. The non-transitory computer-readable storage medium of claim 19, wherein the condition comprises that the wearable device is under control of the second system, or the wearable device is not connected with a mobile terminal.
